(19) United States
(12) Patent Application Publication
(10) Pub. No.: US 2012/0295539 A1
(43) Pub. Date: Nov. 22, 2012

(54) EHF COMMUNICATION WITH ELECTRICAL ISOLATION AND WITH DIELECTRIC TRANSMISSION MEDIUM

(75) Inventors: Gary D. McCormack, Tigard, OR (US); Ian A. Kyles, West Linn, OR (US)

(73) Assignee: WAVECONNEX, INC., Westlake Village, CA (US)

(21) Appl. No.: 13/541,543

(22) Filed: Jul. 3, 2012

Related U.S. Application Data
(63) Continuation-in-part of application No. 12/655,041, filed on Dec. 21, 2009.
(60) Provisional application No. 61/504,625, filed on Jul. 5, 2011.
(60) Provisional application No. 61/661,756, filed on Jun. 19, 2012.
(60) Provisional application No. 61/203,702, filed on Dec. 23, 2008.

(51) Int. Cl. H04B 7/24

(52) U.S. Cl. 455/39

(57) ABSTRACT

A system for transferring electrical signals while providing electrical isolation may include a first circuit and a second circuit electrically isolated from the first circuit. The first circuit may provide a first electrical signal path for conveying a transmit electrical signal and including a first EHF communication unit. The first EHF communication unit may be configured to receive the transmit electrical signal and to electromagnetically transmit an electromagnetic EHF signal representative of the electrical signal. The second circuit may provide a second electrical signal path and including a second EHF communication unit. The second EHF communication unit may be configured to electromagnetically receive the transmitted electromagnetic EHF signal, extract a received electrical signal from the received electromagnetic EHF signal, and apply the received electrical signal to the second electrical signal path. A dielectric element may conduct the electromagnetic EHF signal between the first and second EHF communication units.

### CROSS-REFERENCE TO RELATED APPLICATION

This application claims the benefit of U.S. Provisional Patent Application Ser. No. 61/504,625, filed on Jul. 5, 2011 and entitled “Electrical Isolator Using EHF Coupling” and U.S. Provisional Patent Application Ser. No. 61/661,756, filed on Jun. 19, 2012 and entitled “Dielectric Couplers for EHF Communications.” This application is also a continuation-in-part of U.S. patent application Ser. No. 12/655,041, filed Dec. 21, 2009, which claims the benefit of U.S. Provisional Application Ser. No. 61/203,702, filed Dec. 23, 2008. Each of these prior applications is incorporated herein by reference in its entirety for all purposes.

### FIELD OF THE DISCLOSURE

This disclosure relates to systems and methods for EHF communications, including communication providing electrical isolation between circuits.

### BACKGROUND OF THE DISCLOSURE

Advances in semiconductor manufacturing and circuit design technologies have enabled the development and production of integrated circuits (ICs) with increasingly higher operational frequencies. In turn, electronic products and systems incorporating such integrated circuits are able to provide much greater functionality than previous generations of products. This additional functionality has generally included the processing of increasingly larger amounts of data at increasingly higher speeds.

Many electronic systems include multiple printed circuit boards (PCBs) upon which these high-speed ICs are mounted, and through which various signals are routed to and from the ICs. In electronic systems with at least two PCBs and the need to communicate information between those PCBs, a variety of connector and backplane architectures have been developed to facilitate information flow between the boards. Connector and backplane architectures introduce a variety of impedance discontinuities into the signal path, resulting in a degradation of signal quality or integrity. Connecting to boards by conventional means, such as signal-carrying mechanical connectors, generally creates discontinuities, requiring expensive electronics to negotiate. Conventional mechanical connectors may also wear out over time, require precise alignment and manufacturing methods, and are susceptible to mechanical jostling.

### SUMMARY OF THE DISCLOSURE

In one example, a system for transferring electrical signals while providing electrical isolation may include a first circuit and a second circuit electrically isolated from the first circuit. The first circuit may provide a first electrical signal path for conveying a transmit electrical signal and including a first EHF communication unit. The first EHF communication unit may be configured to receive the transmit electrical signal and to electromagnetically transmit an electromagnetic EHF signal representative of the electrical signal. The second circuit may provide a second electrical signal path and including a second EHF communication unit. The second EHF communication unit may be configured to electromagnetically receive the transmitted electromagnetic EHF signal, extract a received electrical signal from the received electromagnetic EHF signal, and apply the received electrical signal to the second electrical signal path.

In another example, a method for transferring electrical signals while providing electrical isolation may include conveying a transmit electrical signal on a first electrical signal path of a first circuit, and receiving the transmit electrical signal in a first EHF communication unit of the first circuit. A first electromagnetic EHF signal representative of the transmit electrical signal may be transmitted. The transmitted electromagnetic EHF signal may be received in a second EHF communication unit of a second circuit electrically isolated from the first circuit. The received electrical signal may be extracted from the received electromagnetic EHF signal, the received electrical signal being representative of the transmit electrical signal. The extracted received electrical signal may then be applied to a second electrical signal path of the second circuit.

In another example, a communication system may provide communication along a communication pathway between first and second EHF communication units using an electromagnetic EHF signal. The communication system may include a dielectric element having opposite ends. The dielectric element may conduct an electromagnetic EHF signal when positioned to extend between the first EHF communication unit and the second EHF communication unit with the ends proximate respective ones of the EHF communication units and in the communication pathway. The dielectric element may receive the electromagnetic EHF signal in one end and conduct the electromagnetic EHF signal through the dielectric element to the other end.

In a further example, a method for communicating may include positioning a dielectric element having opposite ends between first and second EHF communication units with each of the ends proximate a respective one of the EHF communication units. An electromagnetic EHF signal may be produced from the first EHF communication unit. The electromagnetic EHF signal may be conducted in the dielectric element between the first EHF communication unit and the second EHF communication unit and in the communication pathway. The dielectric element may receive the electromagnetic EHF signal in one end and conducting the electromagnetic EHF signal through the dielectric element to the other end. The conducted electromagnetic EHF signal may be output from the dielectric element to the second EHF communication unit.

Advantages of such systems and methods will be more readily understood after considering the drawings and the Detailed Description.

### BRIEF DESCRIPTION OF THE DRAWINGS

FIG. 1 shows a simplified schematic overhead view of a first example of an integrated circuit (IC) package including a die and antenna.

FIG. 2 shows a schematic side view of an exemplary communication device including an IC package and printed circuit board (PCB).

FIG. 3 shows an isometric view of another exemplary communication device including an IC package with external circuit conductors.

FIG. 4 shows a bottom view of the exemplary communication device of FIG. 3.

FIG. 5 shows an example of a communication system including first and second communication units with PCB ground planes and a stylized representation of a resulting radiation pattern.

FIG. 6 illustrates the communication of FIG. 5 in which a portion of the PCB is formed into a dielectric guide.

FIG. 7 shows a side view of a further example of a communication system having first and second communication units mounted as a single package on a PCB.

FIG. 8 illustrates a plan view of the communication system of FIG. 6.

FIG. 9 is a block diagram of an example of a communication system including two transceivers.

### DETAILED DESCRIPTION OF THE DISCLOSURE

Wireless communication may be used to provide signal communications between components on a device or may provide communication between devices. Wireless communication provides an interface that is not subject to mechanical and electrical degradation. Examples of systems employing wireless communication between chips are disclosed in U.S. Pat. No. 5,621,913 and U.S. Published Patent Application No. 2010/0159829, the disclosures of which are incorporated herein by reference in their entirety for all purposes.

In one example, tightly-coupled transmitter/receiver pairs may be deployed with a transmitter disposed at a terminal portion of a first conduction path and a receiver disposed at a terminal portion of a second conduction path. The transmitter and receiver may be disposed in close proximity to each other depending on the strength of the transmitted energy, and the first conduction path and the second conduction path may not be contiguous with respect to each other. In some examples, the transmitter and receiver may be disposed on separate circuit carriers positioned with the antennas of the transmitter/receiver pair in close proximity.

As discussed below, a transmitter and/or receiver may be configured as an IC package, in which one or more antennas may be positioned adjacent to a die and held in place by a dielectric or insulating encapsulation or bond material. An antenna may also be held in place by a lead frame substrate. Examples of EHF antennas embedded in IC packages are shown in the drawings and described below. Note that IC packages may also be referred to as EHF IC packages or simply packages, and are examples of wireless communication units that are also variously referred to as EHF communication units, communication units, communication devices, comm-link chip packages, and/or comm-link packages.

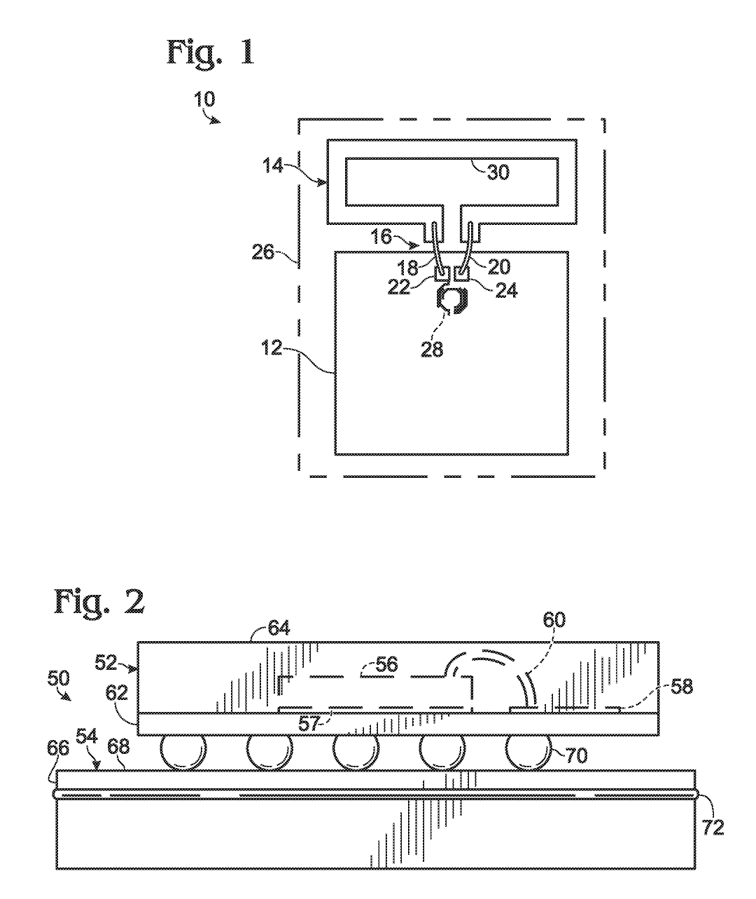

FIG. 1 shows an exemplary IC package, generally indicated at 10. IC package 10 includes a chip or die 12, a transducer 14 providing conversion between electrical and electromagnetic (EM) signals, and conductive connectors 16, such as bond wires 18, 20 electrically connecting the transducer to bond pads 22, 24 connected to a transmitter or receiver circuit included in die 12. IC package 10 further includes an encapsulating material 26 formed around at least a portion of the die and/or the transducer. In this example encapsulating material 26 covers die 12, conductive connectors 16, and transducer 14, and is shown in phantom lines so that details of the die and transducer may be illustrated in solid lines.

Die 12 includes any suitable structure configured as a miniaturized circuit on a suitable die substrate, and is functionally equivalent to a component also referred to as a chip or an integrated circuit (IC). A die substrate may be any suitable semiconductor material; for example, a die substrate may be silicon. Die 12 may have a length and a width dimension, each of which may be about 1.0 mm to about 2.0 mm, and preferably about 1.2 mm to about 1.5 mm. Die 12 may be mounted with further electrical conductors 16, such as a lead frame, not shown in FIG. 1, providing connection to external circuits. A transformer 28, shown in dashed lines, may provide impedance matching between a circuit on die 12 and transducer 14.

Transducer 14 may be in the form of a folded dipole or loop antenna 30, may be configured to operate at radio frequencies such as in the EHF spectrum, and may be configured to transmit and/or receive electromagnetic signals. Antenna 30 is separate from but operatively connected to die 12 by suitable conductors 16, and is located adjacent to die 12.

The dimensions of antenna 30 are suitable for operation in the EHF band of the electromagnetic frequency spectrum. In one example, a loop configuration of antenna 30 includes a 0.1 mm band of material, laid out in a loop 1.4 mm long and 0.53 mm wide, with a gap of 0.1 mm at the mouth of the loop, and with the edge of the loop approximately 0.2 mm from the edge of die 12.

Encapsulating material 26 is used to assist in holding the various components of IC package 10 in fixed relative positions. Encapsulating material 26 may be any suitable material configured to provide electrical insulation and physical protection for the electrical and electronic components of IC package 10. For example, encapsulating material 26, also referred to as insulating material, may be a mold compound, glass, plastic, or ceramic. Encapsulating material 26 may also be formed in any suitable shape. For example, encapsulating material 26 may be in the form of a rectangular block, encapsulating all components of IC package 10 except the unconnected ends of conductors 16 connecting the die to external circuits. External connections may be formed with other circuits or components.

FIG. 2 shows a representational side view of a communication device 50 including an IC package 52 flip-mounted to an exemplary printed circuit board (PCB) 54. In this example, it may be seen that IC package 52 includes a die 56, a ground plane 57, an antenna 58, bond wires, including bond wire 60, connecting the die to the antenna. The die, antenna, and bond wires are mounted on a package substrate 62 and encapsulated in encapsulating material 64. Ground plane 57 may be mounted to a lower surface of die 56, and may be any suitable structure configured to provide an electrical ground for the die. PCB 54 may include a top dielectric layer 66 having a major face or surface 68. IC package 52 is flip-mounted to surface 68 with flip-mounting bumps 70 attached to a metallization pattern (not shown).

PCB 54 may further include a layer 72 spaced from surface 68 made of conductive material forming a ground plane within PCB 54. The PCB ground plane may be any suitable structure configured to provide an electrical ground to circuits and components on PCB 54.

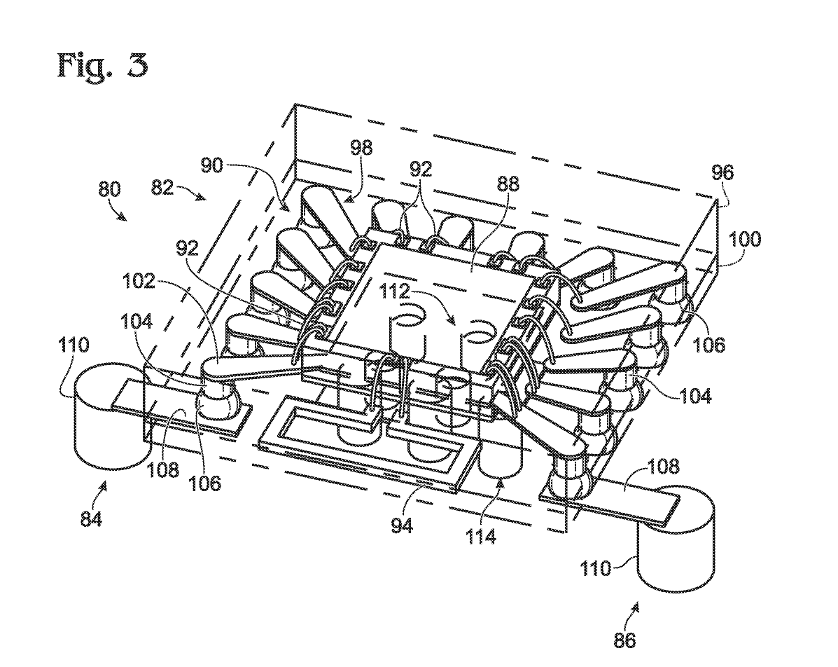

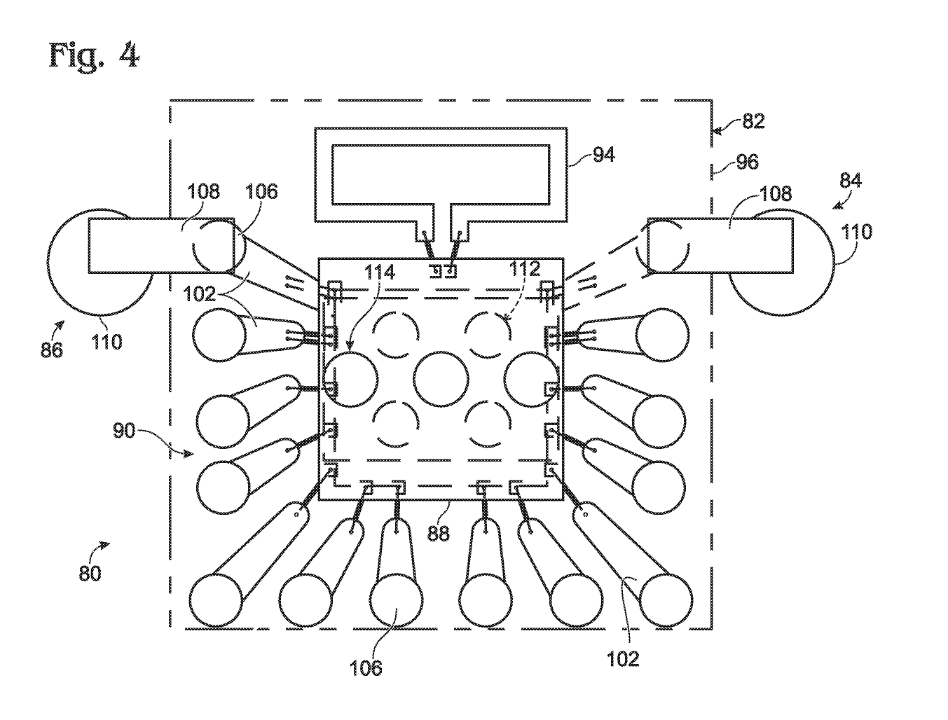

FIGS. 3 and 4 illustrate another exemplary communication device 80 including an IC package 82 with external circuit conductors 84 and 86. In this example, IC package 82 may include a die 88, a lead frame 90, conductive connectors 92 in the form of bond wires, an antenna 94, encapsulating material 96, and other components not shown to simplify the illustration. Die 88 may be mounted in electrical communication with lead frame 90, which may be any suitable arrangement of electrical conductors or leads 98 configured to allow one or more other circuits to operatively connect with die 90. Antenna 94 may be constructed as a part of the manufacturing process that produces lead frame 90.

Leads 98 may be embedded or fixed in a lead frame substrate 100, shown in phantom lines, corresponding to package substrate 62. The lead frame substrate may be any suitable insulating material configured to substantially hold leads 98 in a predetermined arrangement. Electrical communication between die 88 and leads 98 of lead frame 90 may be accomplished by any suitable method using conductive connectors 92. As mentioned, conductive connectors 92 may include bond wires that electrically connect terminals on a circuit of die 88 with corresponding lead conductors 98. For example, a conductor or lead 98 may include a plated lead 102 formed on an upper surface of lead frame substrate 100, a via 104 extending through the substrate, a flip-mounting bump 106 mounting IC package 82 to a circuit on a base substrate, such as a PCB, not shown. The circuit on the base substrate may include external conductors, such as external conductor 84, which for example, may include a strip conductor 108 connecting bump 106 to a further via 110 extending through the base substrate. Other vias 112 may extend through the lead frame substrate 100 and there may be additional vias 114 extending through the base substrate.

In another example, die 88 may be inverted and conductive connectors 92 may include bumps, or die solder balls, as described previously, which may be configured to electrically connect points on a circuit of die 88 directly to corresponding leads 98 in what is commonly known as a “flip chip” arrangement.

A first and a second IC package 10 may be co-located on a single PCB and may provide intra-PCB communication. In other examples, a first IC package 10 may be located on a first PCB and a second IC package 10 may be located on a second PCB and may therefore provide inter-PCB communication.

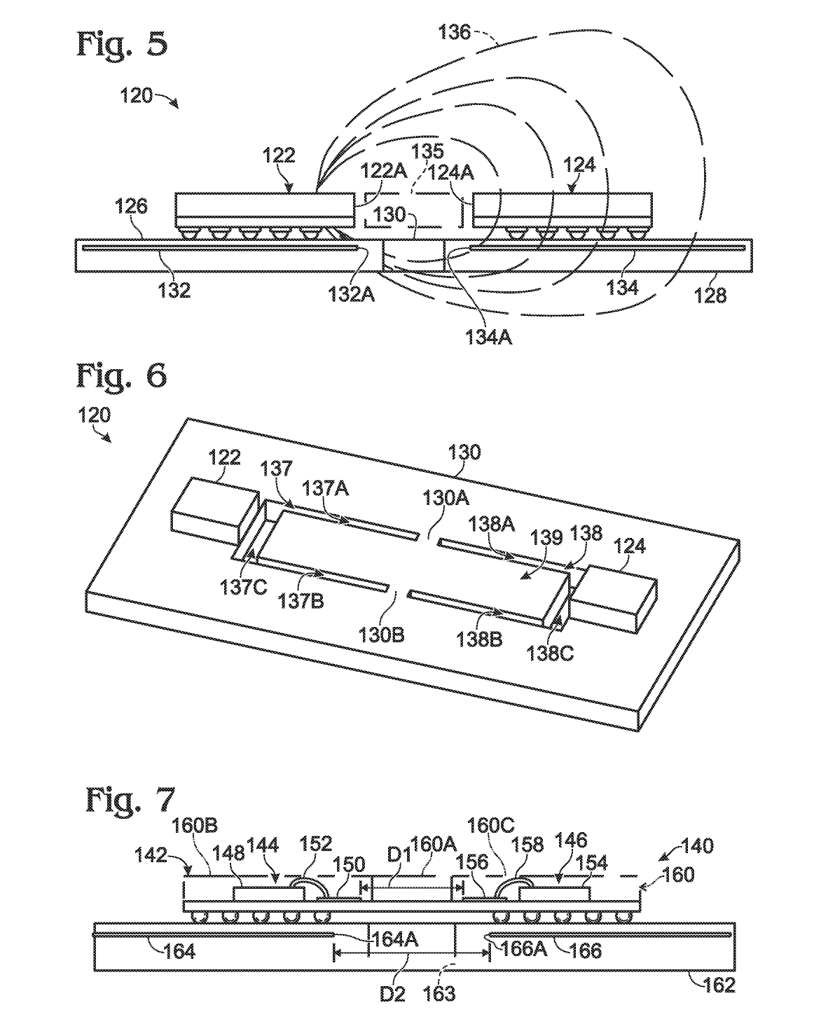

As shown in FIG. 5, a exemplary communication system 120 may include a first IC package 122 may be mounted for communication with a second IC package 124 that is electrically isolated from first IC package 122. Each IC package includes a respective communication unit. This figure illustrates idealized radiation patterns that may result from transmission of electromagnetic EHF radiation from first IC package 122 to second IC package 124. The radiation pattern shown is not the result of a simulation of the configuration shown but is intended to be representative of the general form of the radiation pattern. Actual radiation patterns are dependent on relative configurations and actual associated structures.

IC packages 122 and 124 may be configured to transmit and/or receive electromagnetic signals, providing one- or two-way communication between the two IC packages and any respective accompanying electronic circuits or components that each is connected to. First IC package 122 is shown mounted to a first PCB 126 and second IC package 124 is shown mounted to a second PCB 128, whereby the IC packages provide inter-PCB communication. In other examples, first and second IC packages 122 and 124 may be co-located on a single PCB, such as PCB 130, as indicated by the phantom lines between the PCBs to provide intra-PCB communication.

Additionally, a ground plane 132 in PCB 126 may have a leading edge 132A that is generally in line with the antenna end 122A of IC package 122. Similarly, a ground plane 134 in PCB 128 may have a leading edge 134A that is generally in line with the antenna end 124A of IC package 124. Ground planes 132 and 134 and the respective associated circuits of first and second IC packages 122 and 124 may be physically as well as electrically isolated from each other. With the ground planes recessed under IC packages 122 and 124, it is seen that the radiation 136 extends from end 122A directly toward end 124A to the right in FIG. 5. The radiation may thereby be directed toward receiver IC package 126, depending on the actual configuration used. The configuration of a ground plane relative to the antenna may thus also function as a radiation shaper. Radiation 136 may be better contained by use of a dielectric element 135 extending between and separate from IC packages 124 and 126, whether the IC packages are mounted on separate PCBs 126 and 128, or a single PCB 130.

Dielectric element 135 may be configured to function as a guide for radiation, generally referred to as a dielectric guide, or as a waveguide, as described in further detail below. Accordingly, it will be appreciated that an antenna in EHF communication unit in IC package 122 may direct an electromagnetic EHF signal in the radiation in a first given direction to the right from IC package end 122A as shown in the figure. Similarly, an antenna in a second EHF communication unit in IC package 124 may be disposed to receive an electromagnetic EHF signal directed in a second given direction extending to the left from IC package end 124A. The left end of the dielectric element 135, as shown in the figure, may be disposed proximate and in the first given direction from the antenna associated with IC package end 122A and the other, right end of the dielectric element may be disposed proximate and in the second given direction from the antenna associated with IC package end 124A. In this position, the dielectric element will conduct the radiation between IC package ends 122A and 124A regardless of the direction that the radiation is being transmitted. The first and second directions may be different directions.

FIG. 6 illustrates communication system 120 including a single PCB 130. A pair of opposing U-shaped channels 137 and 138 formed in PCB 130 between IC packages 122 and 124 form a dielectric guide 139 extending nearly continuously between the IC packages that is coplanar with the PCB. The U-shaped channels include respective opposing channels 137A and 137B, 138A and 138B, and connecting channel portions 137C and 138C, extending between the opposing channels proximate to the first and second circuits, as shown. Dielectric guide 139 is connected by thin bridges intermittently to the main body of the PCB, such as by bridges 130A and 130B shown centrally located in the dielectric guide and separating channels 137 and 138. Dielectric guide 139 conducts electromagnetic energy transmitted between the IC packages without being in contact with the IC packages, further enhancing isolation. The dielectric guide may also be a unitary structure separate from and supported in or on the PCB.

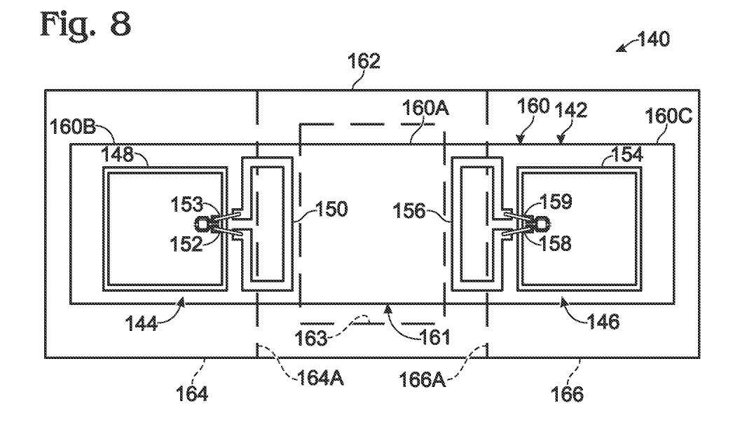

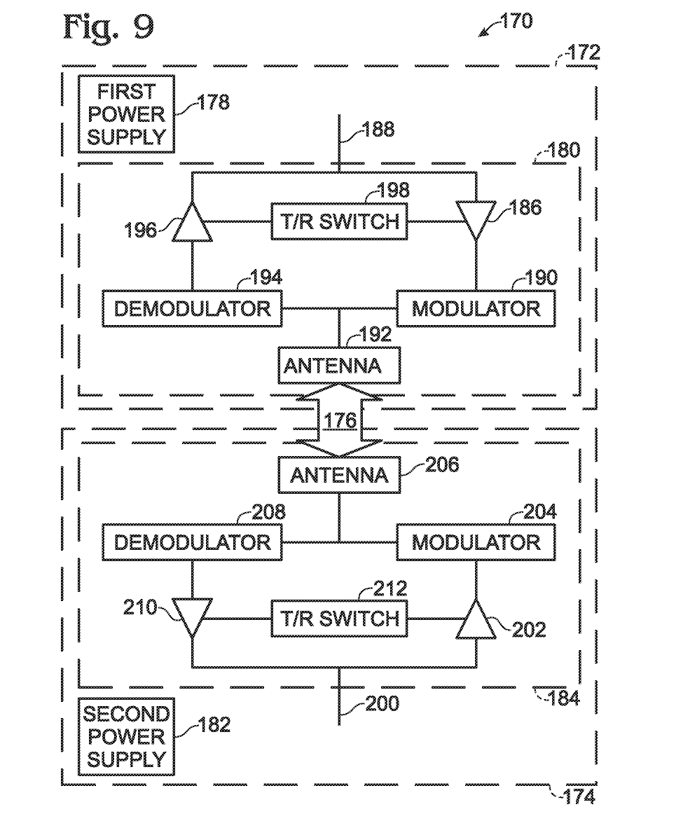

Referring to FIGS. 7 and 8, a further example of a communication circuit 140 is shown. Communication system 140 may include a single IC package 142 that includes a first communication unit 144 and a second communication unit 146. Communication units 144 and 146 are mounted for communication with each other and they are electrically isolated from each other. Communication units 144 and 146 may be configured to transmit and/or receive electromagnetic signals, providing one- or two-way communication between the two communication units and any respective accompanying electronic circuits or components that each is connected to.

Communication unit 144 includes an IC 148 connected to an antenna 150 by bond wires 152 and 153. Communication unit 146 includes an IC 154 connected to an antenna 156 by bond wires 158 and 159. The leading edge of antenna 150 is separated from the leading edge of antenna 156 by a distance D1. Communication units 144 and 146 are covered by and the space between them is filled with a solid dielectric 160. Electromagnetic radiation travels between antenna 150 and antenna 156 through dielectric portion 160A.

Dielectric portion 160A may be made of a piece of solid dielectric material, a dielectric element, that is separate from the dielectric included in communication units 144 and 146 and may be flexible and/or have bends in it, or it may be rigid, the material being chosen to provide characteristics appropriate for the particular application. In this example, then, communication units 144 and 146 have separate respective dielectric portions 160B and 160C, forming separate IC packages, similar to IC packages 122 and 124 shown in FIGS. 5 and 6. The ends of the dielectric element may each be positioned in a direction relative to the associated antennas consistent with a direction in which the respective antenna directs radiation.

Dielectric portion 160A preferably has a rectangular cross section and forms a dielectric guide 161 that conducts electromagnetic energy transmitted between the communication units. EHF radiation may be substantially contained within the dielectric portion. Dielectric portion 160A may form an insulating barrier between opposing ends adjacent to the communication units. Improved isolation may be realized by choosing a dielectric material having a relatively high voltage breakdown characteristic. For example, epoxy mold compound typically used for semiconductor packaging may provide about 20 KV per millimeter. One centimeter of ABS thus may provide 200 KV of isolation before breakdown occurs. Longer spans may also be used, increasing the breakdown voltage further and reducing parasitic leakage effects.

Containment of the radiation may be improved by surrounding the dielectric guide with a graded or lower dielectric-constant layer. In this example, air surrounds three sides of the dielectric guide, and the PCB extends along the fourth side. Radiation containment may accordingly be improved, by removing a portion of the PCB to create a region 163, shown in dashed lines, that may be a void filled with air or may be a portion of dielectric having a solid dielectric material with a lower dielectric constant than the dielectric guide. The dielectric guide may be resistant to signal path interference, and with the dielectric guide suspended over a void region 163, a parasitic leakage path otherwise extending through this portion of the PCB may be eliminated.

IC package 142 is mounted to a single PCB 162. Additionally, a ground plane 164 in PCB 162 under communication unit 144 and may have a leading edge 164A that is recessed under communication unit 144 from the leading edge of antenna 150. Similarly, a ground plane 166 in PCB 162 under communication unit 146 may have a leading edge 166A that is recessed under communication unit 146 from the leading edge of antenna 156. The leading edges 150A and 156A of the ground planes are spaced a distance D2 apart. Distance D2 is greater than distance D1 between the leading edges of the antennas. Ground planes 164 and 166 are also electrically isolated and are respectively operatively coupled to communication units 144 and 146.

Referring now to FIG. 8, a block diagram of an example of a communication system 170 including two transceivers is illustrated. Communication system 170 may be used as a communication system 120 or a communication system 140 described above. In this example, communication system 170 includes a first circuit 172 and a second circuit 174 that are electrically isolated while communicating with each other using electromagnetic EHF signals 176.

Circuit 172 may include a first power supply 178 and a first EHF communication unit 180, as well as other circuits (not shown) as appropriate for a particular application. Circuit 174 may include a second power supply 182 and a second EHF communication unit 184, in addition to any other appropriate circuits. Each of communication units 180 may be formed as integrated circuits on one or more substrates, and may be a separate IC package, as shown in FIG. 5, or the first and second communication units may be part of a common IC package, as shown in FIGS. 6 and 7.

When communication unit 180 may be a transceiver and when operating in a transmit mode may include an amplifier 186 that receives a transmit baseband signal on a baseband conductor 188, and amplifies the signal for input to a modulator 190. Modulator 190 may apply the baseband signal to an EHF carrier signal produced by an EHF oscillator (not shown) to produce a transmit electrical EHF signal that is communicated to an antenna 192 for transmission as a transmit electromagnetic EHF signal 176. When functioning in a receive mode, a receive electromagnetic EHF signal 176 is received by antenna 192 and converted to a receive electrical EHF signal for input to a demodulator 194. Demodulator 194 may include, for example, cascaded amplifiers and a self-mixer detector circuit for converting the receive electrical EHF signal into a receive baseband signal that is amplified by an amplifier 196 to produce an amplified receive baseband signal on conductor 188. Operation of communication unit 180 in transmit and receive modes may be controlled by a transmit/receive switch 198.

Communication unit 184 may be constructed functionally similar to communication unit 180, if not the same. Accordingly, communication unit 184 may have a baseband conductor 200, a transmit amplifier 202, a modulator 204, an antenna 206, a demodulator 208, a receive amplifier 210, and a transmit/receive switch 212.

It will be appreciated that the communication system disclosed use a modulated EHF carrier to couple signals across an air or dielectric medium. This may provide enhanced separation and hence isolation voltage between the respective circuits. Isolation may be provided with a small footprint using two chips to form the respective circuits. A very high data rate may be realized due to a high frequency modulation capability of the circuits. Parts of a system that have radically different ground and power potentials may thus be electrically isolated to prevent damage to equipment or users.

This solution may also produce low EMI due to the use of high frequency energy that has relatively rapid attenuation with distance. There may also be low need for proximity and special dielectrics, thereby allowing for relatively large separation, and tolerance to misalignments during assembly. With few components required, and few exotic components, such as special capacitors, LEDs, photo-detectors, assembly may be facilitated at a relatively low cost. Common CMOS technology may be used to make the communication units, which provides for portability and economies of scale. Additionally, EHF circuits can handle very rapid modulation for increased data throughput.

Accordingly, a system or method as described above for providing electrical isolation and/or a dielectric element for conducting using electromagnetic EHF signals may include one or more of the following examples.

A system for transferring electrical signals while providing electrical isolation may comprise a first circuit providing a first electrical signal path for conveying a transmit electrical signal and including a first EHF communication unit configured to receive the transmit electrical signal and to electromagnetically transmit an electromagnetic EHF signal representative of the electrical signal; and a second circuit electrically isolated from the first circuit, the second circuit providing a second electrical signal path and including a second EHF communication unit configured to electromagnetically receive the transmitted electromagnetic EHF signal, extract a received electrical signal from the received electromagnetic EHF signal, and apply the received electrical signal to the second electrical signal path.

The first EHF unit may be configured to modulate a transmit electrical EHF signal based on the received transmit electrical signal. The second EHF unit may be configured to demodulate the received electromagnetic EHF signal to produce a receive electrical signal representative of the transmit electrical signal. The first circuit and the second circuit may both be disposed on a single printed circuit board (PCB).

A system may include a dielectric material extending along the PCB between the first and second circuits. A portion of the PCB between the first and second circuits may have a lower dielectric constant than a portion of the PCB on which the first and second circuits are mounted. A portion of the PCB between the first and second circuits may be a void filled with air and dielectric material extending along the PCB between the first and second circuits may be suspended over the void.

A dielectric material extending along the PCB between the first and second circuits may be a dielectric guide, such as a waveguide, having a rectangular cross-section. The first and second circuits may be formed as separate IC packages, and the dielectric guide may be separate from the IC packages. The dielectric guide may be coplanar with the PCB. The PCB may include opposing channels formed in the PCB and extending between the first and second circuits. The PCB may include U-shaped channels including the opposing channels and connecting channel portions extending between the opposing channels proximate to the first and second circuits.

In some examples, the first EHF communication unit and the second EHF communication unit may be disposed in a common integrated circuit (IC) package. The first circuit and the second circuit may both be disposed in the common IC package. The first EHF communication unit may include a first antenna for converting a transmit electrical EHF signal representative of the transmit electrical signal into the electromagnetic EHF signal and directing the electromagnetic EHF signal in a given direction along the PCB. The second EHF communication unit may include a second antenna disposed in the given direction from the first antenna for receiving the transmitted electromagnetic EHF signal and for converting the received electromagnetic EHF signal into a received electrical EHF signal.

A common IC package may include a dielectric portion covering and extending continuously between the first and second antennas. The PCB may include a first ground plane aligned with the first EHF communication unit and a second ground plane physically spaced from and electrically isolated from the first ground plane, the second ground plane being aligned with the second EHF communication unit. The first and second ground planes may be spaced further apart than a distance between the first and second antennas.

In some examples, the first circuit may be disposed on a first PCB and the second circuit is disposed on a second PCB. A dielectric portion may be disposed between the first EHF communication unit and the second EHF communication unit. Each of the first and second EHF communication units may include an integrated circuit (IC) package having a chip, insulating material, and an antenna located in the IC package and held in a fixed location by the insulating material. Each of the first and second EHF communication units may include a lead frame and have a ground plane operatively connected to the IC. The antenna may be configured to operate at a predetermined wavelength and the lead frame includes a plurality of separate conductor elements arranged sufficiently close together to reflect electromagnetic energy having the predetermined wavelength.

The first circuit may have a first power supply and the second circuit may have a second power supply that is electrically isolated from the first power supply. The first circuit may have a first electrical ground and the second circuit may have a second electrical ground that is electrically isolated from the first electrical ground. At least one of the first and second EHF communication units may be configured as a transceiver.

In some examples, a method may be for transferring electrical signals while providing electrical isolation. The method may include conveying a transmit electrical signal on a first electrical signal path of a first circuit; receiving the transmit electrical signal in a first EHF communication unit of the first circuit; transmitting a first electromagnetic EHF signal representative of the transmit electrical signal; receiving the transmitted electromagnetic EHF signal in a second EHF communication unit of a second circuit electrically isolated from the first circuit; extracting a received electrical signal from the received electromagnetic EHF signal, the received electrical signal being representative of the transmit electrical signal; and applying the extracted received electrical signal to a second electrical signal path of the second circuit.

The method may further include converting the transmit electrical signal into a transmit electrical EHF signal, and modulating by the first EHF communication unit the transmit electrical EHF signal based on the transmit electrical signal. The method may include converting the received electromagnetic EHF signal into a received electrical EHF signal, and demodulating by the second EHF communication unit the received electrical EHF signal to recreate the received electrical signal.

Transmitting an electromagnetic EHF signal may include transmitting an electromagnetic EHF signal between the first circuit and the second circuit on a single printed circuit board (PCB). Transmitting an electromagnetic EHF signal may include transmitting an electromagnetic EHF signal between the first circuit and the second circuit through a dielectric material extending along the PCB between the first and second circuits. The method may include suspending dielectric material extending along the PCB between the first and second circuits over a void in the PCB.

Transmitting an electromagnetic EHF signal between the first circuit and the second circuit through a dielectric material extending along the PCB between the first and second circuits may include transmitting the electromagnetic EHF signal between the first and second circuits through a dielectric guide that is coplanar with the PCB. The dielectric guide may be formed by forming opposing channels in the PCB that extend between the first and second circuits. Forming opposing channels in the PCB that extend between the first and second circuits may include forming U-shaped channels including the opposing channels and connecting channel portions extending between the opposing channels proximate to the first and second circuits.

Transmitting an electromagnetic EHF signal between the first circuit and the second circuit may include transmitting an electromagnetic EHF signal between the first EHF communication unit and the second EHF communication unit through a solid dielectric covering and extending continuously between the first EHF communication unit and the second EHF communication unit.

Transmitting an electromagnetic EHF signal may include transmitting an electromagnetic EHF signal between the first circuit disposed on a first PCB and the second circuit disposed on a second PCB. Transmitting an electromagnetic EHF signal may include transmitting an electromagnetic EHF signal through a solid dielectric portion extending continuously between the first EHF communication unit and the second EHF communication unit. Transmitting an electromagnetic EHF signal may include transmitting an electromagnetic EHF signal having a predetermined wavelength, and reflecting the electromagnetic EHF signal from a lead frame of the first EHF communication unit, the lead frame may have a plurality of separate conductor elements arranged sufficiently close together to reflect electromagnetic energy having the predetermined wavelength.

A method may include powering the first circuit with a first power supply and powering the second circuit with a second power supply electrically isolated from the first power supply. The first circuit may be grounded with a first electrical ground, and the second circuit may be grounded with a second electrical ground electrically isolated from the first electrical ground. A method may include transmitting a second electromagnetic EHF signal from the second EHF communication unit, and receiving the transmitted second electromagnetic EHF signal in the first EHF communication unit.

In some examples, a communication system for communicating along a communication pathway between first and second EHF communication units using an electromagnetic EHF signal may include a dielectric element having opposite ends. The dielectric element may conduct an electromagnetic EHF signal when positioned to extend between the first EHF communication unit and the second EHF communication unit with the ends proximate respective ones of the EHF communication units and in the communication pathway, the dielectric element receiving the electromagnetic EHF signal in one end and conducting the electromagnetic EHF signal through the dielectric element to the other end.

The first and second EHF communication units may be disposed on a single printed circuit board (PCB) and the dielectric element may extend along the PCB between the first and second EHF communication units. The system may include the first and second EHF communication units and the PCB, with a portion of the PCB between the first and second EHF communication units having a lower dielectric constant than a portion of the PCB on which the first and second EHF communication units are mounted. The portion of the PCB between the first and second circuits may be a void filled with air and the dielectric element extending along the PCB between the first and second circuits may be suspended over the void.

The dielectric element extending along the PCB between the first and second EHF communication units may be a dielectric guide and may have a rectangular cross-section. The first and second EHF communication units may be formed as separate IC packages, and the dielectric element may be separate from the IC packages. The dielectric element may be coplanar with the PCB. The PCB may include opposing channels formed in the PCB and extending between the first and second EHF communication units. The PCB may include U-shaped channels including the opposing channels and connecting channel portions extending between the opposing channels proximate to the first and second circuits.

The first EHF communication unit and the second EHF communication unit may be disposed in a common integrated circuit (IC) package including the dielectric element. The first EHF communication unit may include a first antenna for converting a transmit electrical EHF signal representative of the transmit electrical signal into the electromagnetic EHF signal and directing the electromagnetic EHF signal in a first given direction along the PCB. The second EHF communication unit may include a second antenna disposed in the first given direction from the first antenna, with the dielectric element extending along the first direction. The PCB may include a first ground plane aligned with the first EHF communication unit and a second ground plane physically spaced from and electrically isolated from the first ground plane, the second ground plane being aligned with the second EHF communication unit. The first and second ground planes may be spaced further apart than a distance between the first and second antennas.

The first circuit may be disposed on a first PCB and the second circuit may be disposed on a second PCB. The first EHF communication unit may include a first antenna for converting a transmit electrical EHF signal representative of the transmit electrical signal into the electromagnetic EHF signal and directing the electromagnetic EHF signal in a first given direction along the PCB. The second EHF communication unit may include a second antenna disposed in a second given direction, one end of the dielectric element may be disposed in the first given direction from the first antenna and the other end of the dielectric element may be disposed in the second given direction from the second antenna.

Each of the first and second EHF communication units may include an integrated circuit (IC) package having a chip, insulating material, and an antenna located in the IC package and held in a fixed location by the insulating material. At least one of the first and second EHF communication units may be configured as a transceiver.

In further examples, a method for communicating includes positioning a dielectric element having opposite ends between first and second EHF communication units with each of the ends proximate a respective one of the EHF communication units; producing an electromagnetic EHF signal from the first EHF communication unit; conducting the electromagnetic EHF signal in the dielectric element between the first EHF communication unit and the second EHF communication unit and in the communication pathway, the dielectric element receiving the electromagnetic EHF signal in one end and conducting the electromagnetic EHF signal through the dielectric element to the other end; and outputting the conducted electromagnetic EHF signal from the dielectric element to the second EHF communication unit.

The method further may include positioning the dielectric element between first and second EHF communication units mounted on a single printed circuit board (PCB), suspending the dielectric element along the PCB between the first and second circuits over a void in the PCB, and/or positioning a dielectric element having opposite ends between first and second EHF communication units coplanar with the PCB.

In some examples, the method may further include forming a dielectric guide by forming opposing channels in the PCB that extend between the first and second circuits. Forming channels may include forming U-shaped channels that include opposing channels and connecting channel portions extending between the opposing channels proximate to the first and second circuits.

A dielectric element may be a solid dielectric covering and extending continuously between the first EHF communication unit and the second EHF communication unit. A dielectric element may be positioned between the first EHF communication unit disposed on a first PCB and the second EHF communication unit disposed on a second PCB.

In some examples, a method may include producing an electromagnetic EHF signal from the second EHF communication unit; conducting the electromagnetic EHF signal in the dielectric element between the second EHF communication unit and the first EHF communication unit and in the communication pathway, the dielectric element receiving the electromagnetic EHF signal in other end and conducting the electromagnetic EHF signal through the dielectric element to the one end; and outputting the conducted electromagnetic EHF signal from the dielectric element to the first EHF communication unit.

### INDUSTRIAL APPLICABILITY

The inventions described herein relate to industrial and commercial industries, such as electronics and communications industries using devices that communicate with other devices or devices having communication between components in the devices.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

We claim:

1. A system for transferring electrical signals while providing electrical isolation, comprising:
a first circuit providing a first electrical signal path for conveying a transmit electrical signal and including a first EHF communication unit configured to receive the transmit electrical signal and to electromagnetically transmit an electromagnetic EHF signal representative of the electrical signal; and
a second circuit electrically isolated from the first circuit, the second circuit providing a second electrical signal path and including a second EHF communication unit configured to electromagnetically receive the transmitted electromagnetic EHF signal, extract a received electrical signal from the received electromagnetic EHF signal, and apply the received electrical signal to the second electrical signal path.

2. The system of claim 1, wherein the first EHF unit is configured to modulate a transmit electrical EHF signal based on the received transmit electrical signal.

3. The system of claim 2, wherein the second EHF unit is configured to demodulate the received electromagnetic EHF signal to produce a receive electrical signal representative of the transmit electrical signal.

4. The system of claim 1, wherein the first circuit and the second circuit are both disposed on a single printed circuit board (PCB).

5. The system of claim 4, further comprising a dielectric material extending along the PCB between the first and second circuits.

6. The system of claim 5, wherein a portion of the PCB between the first and second circuits has a lower dielectric constant than a portion of the PCB on which the first and second circuits are mounted.

7. The system of claim 6, wherein the portion of the PCB between the first and second circuits is a void filled with air and the dielectric material extending along the PCB between the first and second circuits is suspended over the void.

8. The system of claim 4, wherein the dielectric material extending along the PCB between the first and second circuits is a dielectric guide having a rectangular cross-section.

9. The system of claim 8, wherein the first and second circuits are formed as separate IC packages, and the dielectric guide is separate from the IC packages.

10. The system of claim 8, wherein the dielectric guide is coplanar with the PCB.

11. The system of claim 10, wherein the PCB includes opposing channels formed in the PCB and extending between the first and second circuits.

12. The system of claim 11, wherein the PCB includes U-shaped channels including the opposing channels and connecting channel portions extending between the opposing channels proximate to the first and second circuits.

13. The system of claim 5, wherein the first EHF communication unit and the second EHF communication unit are disposed in a common integrated circuit (IC) package.

14. The system of claim 13, wherein the first circuit and the second circuit are both disposed in the common IC package.

15. The system of claim 13, wherein the first EHF communication unit includes a first antenna for converting a transmit electrical EHF signal representative of the transmit electrical signal into the electromagnetic EHF signal and directing the electromagnetic EHF signal in a given direction along the PCB, and the second EHF communication unit includes a second antenna disposed in the given direction from the first antenna for receiving the transmitted electromagnetic EHF signal and for converting the received electromagnetic EHF signal into a received electrical EHF signal.

16. The system of claim 15, wherein the common IC package includes a dielectric portion covering and extending continuously between the first and second antennas.

17. The system of claim 16, wherein the PCB includes a first ground plane aligned with the first EHF communication unit and a second ground plane physically spaced from and electrically isolated from the first ground plane, the second ground plane being aligned with the second EHF communication unit.

18. The system of claim 17, wherein a distance between the first and second ground planes is longer than a distance between the first and second antennas.

19. The system of claim 1, wherein the first circuit is disposed on a first PCB and the second circuit is disposed on a second PCB.

20. The system of claim 1, further comprising a dielectric portion, wherein the dielectric portion is disposed between the first EHF communication unit and the second EHF communication unit.

21. The system of claim 1, wherein each of the first and second EHF communication units includes an integrated circuit (IC) package having a chip, insulating material, and an antenna located in the IC package and held in a fixed location by the insulating material.

22. The system of claim 21, wherein each of the first and second EHF communication units further includes a lead frame and has a ground plane operatively connected to the IC.

23. The system of claim 22, wherein the antenna is configured to operate at a predetermined wavelength and the lead frame includes a plurality of separate conductor elements arranged sufficiently close together to reflect electromagnetic energy having the predetermined wavelength.

24. The system of claim 1, wherein the first circuit has a first power supply and the second circuit has a second power supply electrically isolated from the first power supply.

25. The system of paragraph 1, wherein the first circuit has a first electrical ground and the second circuit has a second electrical ground electrically isolated from the first electrical ground.

26. The system of claim 1, wherein at least one of the first and second EHF communication units is configured as a transceiver.

27. A method for transferring electrical signals while providing electrical isolation, the method comprising:
conveying a transmit electrical signal on a first electrical signal path of a first circuit;
receiving the transmit electrical signal in a first EHF communication unit of the first circuit;
transmitting a first electromagnetic EHF signal representative of the transmit electrical signal;
receiving the transmitted electromagnetic EHF signal in a second EHF communication unit of a second circuit electrically isolated from the first circuit;
extracting a received electrical signal from the received electromagnetic EHF signal, the received electrical signal being representative of the transmit electrical signal; and
applying the extracted received electrical signal to a second electrical signal path of the second circuit.

28. The method of claim 27, further including converting the transmit electrical signal into a transmit electrical EHF signal, and modulating by the first EHF communication unit the transmit electrical EHF signal based on the transmit electrical signal.

29. The method of claim 28, further including converting the received electromagnetic EHF signal into a received electrical EHF signal, and demodulating by the second EHF communication unit the received electrical EHF signal to recreate the received electrical signal.

30. The method of claim 27, wherein transmitting an electromagnetic EHF signal includes transmitting an electromagnetic EHF signal between the first circuit and the second circuit on a single printed circuit board (PCB).

31. The method of claim 30, wherein transmitting an electromagnetic EHF signal includes transmitting an electromagnetic EHF signal between the first circuit and the second circuit through a dielectric material extending along the PCB between the first and second circuits.

32. The method of claim 31, further comprising suspending the dielectric material extending along the PCB between the first and second circuits over a void in the PCB.

33. The method of claim 30, wherein transmitting an electromagnetic EHF signal between the first circuit and the second circuit through a dielectric material extending along the PCB between the first and second circuits includes transmitting the electromagnetic EHF signal between the first and second circuits through a dielectric guide that is coplanar with the PCB.

34. The method of claim 33, further comprising forming the dielectric guide by forming opposing channels in the PCB that extend between the first and second circuits.

35. The method of claim 34, wherein forming opposing channels in the PCB that extend between the first and second circuits. includes forming U-shaped channels including the opposing channels and connecting channel portions extending between the opposing channels proximate to the first and second circuits.

36. The method of claim 30, wherein transmitting an electromagnetic EHF signal between the first circuit and the second circuit includes transmitting an electromagnetic EHF signal between the first EHF communication unit and the second EHF communication unit through a solid dielectric covering and extending continuously between the first EHF communication unit and the second EHF communication unit.

37. The method of claim 27, wherein transmitting an electromagnetic EHF signal includes transmitting an electromagnetic EHF signal between the first circuit disposed on a first PCB and the second circuit disposed on a second PCB.

38. The method of claim 27, wherein transmitting an electromagnetic EHF signal includes transmitting an electromagnetic EHF signal through a solid dielectric portion extending continuously between the first EHF communication unit and the second EHF communication unit.

39. The method of claim 27, wherein transmitting an electromagnetic EHF signal includes transmitting an electromagnetic EHF signal having a predetermined wavelength, and reflecting the electromagnetic EHF signal from a lead frame of the first EHF communication unit, the lead frame having a plurality of separate conductor elements arranged sufficiently close together to reflect electromagnetic energy having the predetermined wavelength.

40. The method of claim 27, further including powering the first circuit with a first power supply and powering the second circuit with a second power supply electrically isolated from the first power supply.

41. The method of claim 27, further including grounding the first circuit with a first electrical ground, and grounding the second circuit with a second electrical ground electrically isolated from the first electrical ground.

42. The method of claim 27, further including transmitting a second electromagnetic EHF signal from the second EHF communication unit, and receiving the transmitted second electromagnetic EHF signal in the first EHF communication unit.

43. A communication system for communicating along a communication pathway between first and second EHF communication units using an electromagnetic EHF signal, the communication system comprising a dielectric element having opposite ends, the dielectric element conducting an electromagnetic EHF signal when positioned to extend between the first EHF communication unit and the second EHF communication unit with the ends proximate respective ones of the EHF communication units and in the communication pathway, the dielectric element receiving the electromagnetic EHF signal in one end and conducting the electromagnetic EHF signal through the dielectric element to the other end.

44. The system of claim 43, where the first and second EHF communication units are disposed on a single printed circuit board (PCB) and wherein the dielectric element extends along the PCB between the first and second EHF communication units.

45. The system of claim 44, wherein the system includes the first and second EHF communication units and the PCB, a portion of the PCB between the first and second EHF communication units has a lower dielectric constant than a portion of the PCB on which the first and second EHF communication units are mounted.

46. The system of claim 45, wherein the portion of the PCB between the first and second circuits is a void filled with air and the dielectric element extending along the PCB between the first and second circuits is suspended over the void.

47. The system of claim 44, wherein the dielectric element extending along the PCB between the first and second EHF communication units is a dielectric guide having a rectangular cross-section.

48. The system of claim 47, wherein the first and second EHF communication units are formed as separate IC packages, and the dielectric element is separate from the IC packages.

49. The system of claim 47, wherein the dielectric element is coplanar with the PCB.

50. The system of claim 49, wherein the PCB includes opposing channels formed in the PCB and extending between the first and second EHF communication units.

51. The system of claim 50, wherein the PCB includes U-shaped channels including the opposing channels and connecting channel portions extending between the opposing channels proximate to the first and second circuits.

52. The system of claim 44, wherein the first EHF communication unit and the second EHF communication unit are disposed in a common integrated circuit (IC) package including the dielectric element.

53. The system of claim 52, wherein the first EHF communication unit includes a first antenna for converting a transmit electrical EHF signal representative of the transmit electrical signal into the electromagnetic EHF signal and directing the electromagnetic EHF signal in a first given direction along the PCB, and the second EHF communication unit includes a second antenna disposed in the first given direction from the first antenna, with the dielectric element extending along the first direction.

54. The system of claim 53, wherein the PCB includes a first ground plane aligned with the first EHF communication unit and a second ground plane physically spaced from and electrically isolated from the first ground plane, the second ground plane being aligned with the second EHF communication unit.

55. The system of claim 54, wherein a distance between the first and second ground planes is longer than a distance between the first and second antennas.

56. The system of claim 43, wherein the first circuit is disposed on a first PCB and the second circuit is disposed on a second PCB.

57. The system of claim 43, wherein the first EHF communication unit includes a first antenna for converting a transmit electrical EHF signal representative of the transmit electrical signal into the electromagnetic EHF signal and directing the electromagnetic EHF signal in a first given direction along the PCB, and the second EHF communication unit includes a second antenna disposed in a second given direction, one end of the dielectric element being disposed in the first given direction from the first antenna and the other end of the dielectric element being disposed in the second given direction from the second antenna.

58. The system of claim 43, wherein each of the first and second EHF communication units includes an integrated circuit (IC) package having a chip, insulating material, and an antenna located in the IC package and held in a fixed location by the insulating material.

59. The system of claim 43, wherein at least one of the first and second EHF communication units is configured as a transceiver.

60. A method for communicating comprising:
positioning a dielectric element having opposite ends between first and second EHF communication units with each of the ends proximate a respective one of the EHF communication units;
producing an electromagnetic EHF signal from the first EHF communication unit;
conducting the electromagnetic EHF signal in the dielectric element between the first EHF communication unit and the second EHF communication unit and in the communication pathway, the dielectric element receiving the electromagnetic EHF signal in one end and conducting the electromagnetic EHF signal through the dielectric element to the other end; and
outputting the conducted electromagnetic EHF signal from the dielectric element to the second EHF communication unit.

61. The method of claim 60, wherein positioning a dielectric element between first and second EHF communication units includes positioning the dielectric element between first and second EHF communication units mounted on a single printed circuit board (PCB).

62. The method of claim 61, wherein positioning a dielectric element between first and second EHF communication units includes suspending the dielectric element along the PCB between the first and second circuits over a void in the PCB.

63. The method of claim 61, wherein positioning a dielectric element between first and second EHF communication units includes positioning a dielectric element having opposite ends between first and second EHF communication units coplanar with the PCB.

64. The method of claim 63, further comprising forming the dielectric guide by forming opposing channels in the PCB that extend between the first and second circuits.

65. The method of claim 63, wherein forming opposing channels in the PCB that extend between the first and second circuits. includes forming U-shaped channels including the opposing channels and connecting channel portions extending between the opposing channels proximate to the first and second circuits.

66. The method of claim 61, wherein positioning a dielectric element between first and second EHF communication units includes positioning a dielectric element as a solid dielectric covering and extending continuously between the first EHF communication unit and the second EHF communication unit.

67. The method of claim 60, wherein positioning a dielectric element between first and second EHF communication units includes positioning a dielectric element between the first EHF communication unit disposed on a first PCB and the second EHF communication unit disposed on a second PCB.

68. The method of claim 60, further including producing an electromagnetic EHF signal from the second EHF communication unit;
conducting the electromagnetic EHF signal in the dielectric element between the second EHF communication unit and the first EHF communication unit and in the communication pathway, the dielectric element receiving the electromagnetic EHF signal in other end and conducting the electromagnetic EHF signal through the dielectric element to the one end; and
outputting the conducted electromagnetic EHF signal from the dielectric element to the first EHF communication unit.
